(19) United States
(12) Patent Application Publication
(10) Pub. No.: US 2025/0096482 A1
(43) Pub. Date: Mar. 20, 2025

(54) BEAM RECONFIGURABLE ARRAY ANTENNA AND SIGNAL TRANSMITTER APPARATUS EMPLOYING THE SAME

(71) Applicant: Electronics and Telecommunications Research Institute, Daejeon (KR)

(72) Inventors: Jung Nam LEE, Daejeon (KR); Kwang Seon KIM, Daejeon (KR)

(21) Appl. No.: 18/888,999

(22) Filed: Sep. 18, 2024

(30) Foreign Application Priority Data
Sep. 19, 2023 (KR) 10-2023-0124969

(51) Int. Cl. H01Q 21/06; H01Q 3/34; H01Q 13/18

(52) U.S. Cl. CPC H01Q 21/061; H01Q 3/34; H01Q 13/18

(57) ABSTRACT

Exemplary embodiments provide an array antenna which may be used for the middle-range and long-range communications with the high output power and high sensitivity in a high frequency range such as a terahertz frequency band and which allows to effectively implement the beamforming. An array antenna device includes: a plurality of antenna elements periodically arranged to form a two-dimensional planar array; and a plurality of feeding waveguides each provided to supply a transmit signal to a corresponding one of the plurality of antenna elements. Each antenna element may include a resonance cavity and may be coupled to one of the plurality of feeding waveguides at a rear wall. In each antenna element, a plurality of radio wave radiation holes may be formed on a face of the resonance cavity opposite to a position where the feeding waveguide is coupled to the resonance cavity.

### CROSS-REFERENCE TO RELATED APPLICATION

The present application claims a convention priority under 35 U.S.C. § 119(a) based on Korean Patent Application No. 10-2023-0124969 filed on Sep. 19, 2023, the entire content of which is incorporated herein in its entirety by reference.

### BACKGROUND

### 1. Technical Field

The present disclosure relates to an antenna device for a signal transmission and, more particularly, to an antenna device utilizing a resonant cavity. Additionally, the present disclosure relates to a signal transmitter apparatus suitable for reconfiguring and transmitting a beam using the antenna device.

### 2. Related Art

To meet rapidly increasing demand for wireless data transmission, a sixth-generation (6G) communications system to be deployed in the future is likely to adopt a higher frequency band (e.g., terahertz frequency band) than a frequency band of a fifth-generation (5G) communication system. The terahertz frequency band ranges from 0.1 THz to 10 THz and is located between a far-infrared band and a millimeter wave band in an electromagnetic wave spectrum. Since a terahertz wave has a frequency located at a boundary between an electromagnetic wave and a light wave, the terahertz wave has physical properties of penetrating non-metallic media like an electromagnetic wave and a tendency to travel in a straight line like a light wave. The terahertz frequency band may provide a communication service provider with a wider bandwidth than a microwave band and the millimeter wave band, which may be helpful in providing a short-range wireless communications environment of ultra-high-speed and high-capacity. Accordingly, the use of the terahertz frequency band is expected to expand in the 6G or later wireless communications systems.

It is desirable that an antenna to be employed in a future communications system has a high gain and a high sensitivity to facilitate middle-range and long-range communications and allows to apply a beamforming to enable the service provider to provide services to multiple users with beams of narrow beamwidths. Conventional researches on the terahertz frequency band are focused on oscillators for generating signals in the short-range frequency band and detectors for detecting receive signals. However, the oscillators and the detector have drawbacks of a low power and a low sensitivity, and can be used for the short-range signal detections only and is not suitable for a long-range wireless communications.

Among traditional antennas, typical high-gain transmission antennas may include a horn antenna and a cassegrain antenna. However, the horn antenna has a medium level antenna gain and may have a limitations in a long-range transmission. Moreover, antenna elements should be disposed such that distances between adjacent antenna elements are wavelength or smaller (e.g., λ/2-λ/4) in order for an array antenna to operate effectively and implement the beamforming, but it is substantially impossible to dispose the antenna elements so densely and branch and combine signals. The cassegrain antenna has a sufficiently high gain enough to be used in satellite communications but has drawbacks of being large in size, a manufacturing complexity, and high manufacturing costs. Further, in case of the cassegrain antenna, an electronic beamforming is impossible, and a mechanical beamforming in which a sub-reflector of the array antenna is rotated mechanically needs to be used to implement the beamforming. For the mechanical beamforming, however, a separate motor is required, and a beam switching speed may be too low. Besides, a patch array antenna may reveal a too low performance for an actual use since its gain is low and may be further reduced when an array divider line is added to a patch surface.

As such, there may be no antenna solution having the high output power and the high sensitivity in a high frequency range such as the terahertz frequency band enough to facilitate the middle-range and long-range communications and allowing to effectively implement an array antenna for the beamforming.

### SUMMARY

Exemplary embodiments provide an antenna element having a high output power and a high sensitivity in a high frequency range such as a terahertz frequency band enough to facilitate middle-range and long-range communications and allowing to effectively implement an array antenna for a beamforming.

Exemplary embodiments provide an array antenna which may be used for the middle-range and long-range communications with the high output power and the high sensitivity in a high frequency range such as the terahertz frequency band and which allows to effectively implement the beamforming.

Exemplary embodiments provide a signal transmitter device employing the array antenna.

An antenna according to an exemplary embodiment of the present disclosure includes metallic plate in front of a resonator to which a signal is fed through a waveguide, and multiple resonance holes arranged periodically are formed through the metallic plate. The antenna radiates a radio wave signal through the multiple resonance holes and shows an improved antenna gain. An array antenna according to an exemplary embodiment of the present disclosure includes a plurality of resonators. Each resonator may be operated independently from each other to form multiple beams. Meanwhile, phases of signals fed to the resonators may be differentiated to enable a beamforming, and a direction of a radiated beam may be varied according to a user density, which allows an efficient reuse of the frequency.

According to an aspect of an exemplary embodiment, an antenna device includes: a resonance cavity; and a feeding waveguide coupled to a rear wall of the resonance cavity. A plurality of radio wave radiation holes are formed on a face of the resonance cavity opposite to a position where the feeding waveguide is coupled to the resonance cavity.

The plurality of radio wave radiation holes may include: a main radiation hole formed through a front face of the resonance cavity at a position opposite to the position at the rear wall where the feeding waveguide is coupled to the resonance cavity; and a plurality of auxiliary radiation holes formed through the front face of the resonance cavity to surround the main radiation hole.

The resonant cavity may have a polygonal cross section.

The resonant cavity may have a square cross section.

Each of the plurality of radio wave radiation holes mat gave a hexagonal cross section, and the plurality of radio wave radiation holes may be arranged in a shape of a honeycomb.

The main radiation hole may be different from the plurality of auxiliary radiation holes in at least one of a shape and a size.

According to another aspect of an exemplary embodiment, an array antenna device includes: a plurality of antenna elements periodically arranged to form a two-dimensional planar array; and a plurality of feeding waveguides each provided to supply a transmit signal to a corresponding one of the plurality of antenna elements. Each of the plurality of antenna elements may include a resonance cavity and may be coupled to one of the plurality of feeding waveguides at a rear wall. In each of plurality of antenna elements, a plurality of radio wave radiation holes may be formed on a face of the resonance cavity opposite to a position where the feeding waveguide is coupled to the resonance cavity.

The plurality of radio wave radiation holes may include: a main radiation hole formed through a front face of the resonance cavity at a position opposite to the position at the rear wall where the feeding waveguide is coupled to the resonance cavity; and a plurality of auxiliary radiation holes formed through the front face of the resonance cavity to surround the main radiation hole.

The resonant cavity may have a polygonal cross section.

The resonant cavity may have a square cross section.

Each of the plurality of radio wave radiation holes may have a hexagonal cross section, and the plurality of radio wave radiation holes may be arranged in a shape of a honeycomb.

The main radiation hole may be different from the plurality of auxiliary radiation holes in at least one of a shape and a size.

According to yet another aspect of an exemplary embodiment, a signal transmitter apparatus includes: a signal generator configured to generate a transmit signal; a phase shifter configured to receive the transmit signal from the signal generator and adjust the a phase of the transmit signal; and at least one array antenna configured to radiate a phase-adjusted transmit signal from the phase shifter as a wireless signal. The at least one array antenna includes: a plurality of antenna elements periodically arranged to form a two-dimensional planar array; and a plurality of feeding waveguides each provided to supply the phase-adjusted transmit signal to a corresponding one of the plurality of antenna elements. Each of the plurality of antenna elements includes a resonance cavity and is coupled to one of the plurality of feeding waveguides at a rear wall. In each of plurality of antenna elements, a plurality of radio wave radiation holes may be formed on a face of the resonance cavity opposite to a position where the feeding waveguide is coupled to the resonance cavity.

The plurality of radio wave radiation holes may include: a main radiation hole formed through a front face of the resonance cavity at a position opposite to the position at the rear wall where the feeding waveguide is coupled to the resonance cavity; and a plurality of auxiliary radiation holes formed through the front face of the resonance cavity to surround the main radiation hole.

The resonant cavity may have a polygonal cross section.

The resonant cavity may have a square cross section.

Each of the plurality of radio wave radiation holes may have a hexagonal cross section, and the plurality of radio wave radiation holes may be arranged in a shape of a honeycomb.

The main radiation hole may be different from the plurality of auxiliary radiation holes in at least one of a shape and a size.

The plurality of antenna elements may be divided into two or more antenna element groups, and a supply of the phase-adjusted transmit signal may be controlled to turn on and off equally for all antenna elements of each antenna element group.

The plurality of antenna elements may be divided into two or more antenna element groups, and the phase-adjusted transmit signal of which phase may be adjusted by a same amount is supplied for all antenna elements of each antenna element group.

It is very difficult to implement the beamforming by use of conventional high-gain long-range transmission antennas, e.g., horn antennas and cassegrain antennas. In case of the horn antenna, it is difficult to dispose the antenna elements such that distances between adjacent antenna elements are wavelength or smaller for a signal having a very short wavelength, and it is substantially impossible to effectively combine the signals. In case of the cassegrain antenna, a mechanical beamforming in which a sub-reflector of the array antenna is rotated mechanically needs to be used to implement the beamforming, which, however, requires a separate motor and has a limitation that a beam switching speed may be too low. A patch antenna and a low temperature cofired ceramic (LTCC) reveal very large dielectric loss, require a complicated divider line configuration for forming the array antenna is complicated, and show a very large line loss, and thus it is substantially impossible to implement the beamforming by using such antennas.

According to an exemplary embodiment of the present disclosure, a plurality of resonance cavities are integrated in a planar arrangement, and a plurality of radio wave radiation holes are periodically arranged in each of the resonant cavities, so that the radio waves are radiated through the plurality of radio wave radiation holes. Such a structure may improve the antenna gain, eliminate a need for the additional complex and high-loss array divider line, and enable independent operations of the resonant cavities to form multiple beams or perform the beamforming.

When the multiple radio wave radiation holes are arranged in the shape of a honeycomb, the spacing between the antenna elements can be reduced compared with a conventional beam reconfigurable antenna, thereby suppressing grating lobes and minimizing steering errors during a beam steering control.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic diagram of a wireless communications system according to an exemplary embodiment of the present disclosure;

FIG. 2 is a schematic block diagram of a base station and user equipments according to an exemplary embodiment of the present disclosure;

FIG. 3 is a block diagram showing a physical configuration of a transmission controller according to an exemplary embodiment of the present disclosure;

FIG. 4 is a front view of an array antenna according to an exemplary embodiment of the present disclosure;

FIG. 5 is a front view of an antenna element shown in FIG. 4;

FIG. 6 is a cross-sectional view of the antenna element according to an exemplary embodiment of the present disclosure;

FIG. 7 shows a propagation path of a radiation signal in the antenna element shown in FIGS. 5 and 6;

FIG. 8 shows a signal radiation pattern of the antenna element according to an exemplary embodiment of the present disclosure;

FIG. 9A illustrates a general arrangement of radiators and a beam steering control under the general arrangement;

FIG. 9B illustrates an arrangement of radiation holes and a beam steering control under the arrangement according to an exemplary embodiment of the present disclosure;

FIG. 10A shows alternative arrangement patterns of the radiation holes;

FIG. 10B shows alternative arrangement patterns of the radiation holes;

FIGS. 11A-11H show on/off patterns of the antenna elements and resulting radio wave radiation patterns when the array antenna operates as a multiple resonance hole array antenna for passive beamforming;

FIGS. 12A-12H show signal phase arrangement patterns of the antenna elements and resulting radio wave radiation patterns when the array antenna operates as a multiple resonance hole array antenna for active beamforming;

FIG. 13 is an equivalent circuit diagram of a signal receiving stage including an array antenna;

FIG. 14 illustrates an example of a beam steering accomplished by a separation or combining of the array antennas in a massive multiple input-multiple output (massive MIMO) system; and

FIG. 15 is a graph showing simulation results for antenna gains.

The drawings described herein are for illustration purposes only and are not intended to limit the scope of the present disclosure in any way.

### DETAILED DESCRIPTION

For a clearer understanding of the features and advantages of the present disclosure, exemplary embodiments of the present disclosure will be described in detail with reference to the accompanied drawings. However, it should be understood that the present disclosure is not limited to particular embodiments disclosed herein but includes all modifications, equivalents, and alternatives falling within the spirit and scope of the present disclosure. In the drawings, similar or corresponding components may be designated by the same or similar reference numerals.

The terminologies including ordinals such as “first” and “second” designated for explaining various components in this specification are used to discriminate a component from the other ones but are not intended to be limiting to a specific component. For example, a second component may be referred to as a first component and, similarly, a first component may also be referred to as a second component without departing from the scope of the present disclosure. As used herein, the term “and/or” may include a presence of one or more of the associated listed items and any and all combinations of the listed items.

In the description of exemplary embodiments of the present disclosure, “at least one of A and B” may mean “at least one of A or B” or “at least one of combinations of one or more of A and B”. In addition, in the description of exemplary embodiments of the present disclosure, “one or more of A and B” may mean “one or more of A or B” or “one or more of combinations of one or more of A and B”.

When a component is referred to as being “connected” or “coupled” to another component, the component may be directly connected or coupled logically or physically to the other component or indirectly through an object therebetween. Contrarily, when a component is referred to as being “directly connected” or “directly coupled” to another component, it is to be understood that there is no intervening object between the components. Other words used to describe the relationship between elements should be interpreted in a similar fashion.

The terminologies are used herein for the purpose of describing particular exemplary embodiments only and are not intended to limit the present disclosure. The singular forms include plural referents as well unless the context clearly dictates otherwise. Also, the expressions “comprises,” “includes,” “constructed,” “configured” are used to refer a presence of a combination of stated features, numbers, processing steps, operations, elements, or components, but are not intended to preclude a presence or addition of another feature, number, processing step, operation, element, or component.

Unless defined otherwise, all terms used herein, including technical or scientific terms, have the same meaning as commonly understood by those of ordinary skill in the art to which the present disclosure pertains. Terms such as those defined in a commonly used dictionary should be interpreted as having meanings consistent with their meanings in the context of related literatures and will not be interpreted as having ideal or excessively formal meanings unless explicitly defined in the present application.

Exemplary embodiments of the present disclosure will now be described in detail with reference to the accompanying drawings. In order to facilitate general understanding in describing the present disclosure, the same components in the drawings are denoted with the same reference signs, and repeated description thereof will be omitted.

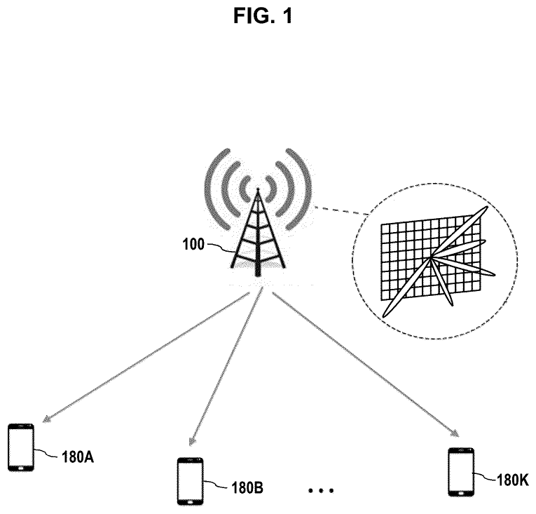

FIG. 1 is a schematic diagram of a wireless communications system according to an exemplary embodiment of the present disclosure. The wireless communications system may include a base station 100 and a plurality of user equipments 120A-120K. The base station 100 can simultaneously communicate with the multiple users, that is, the plurality of user equipments 120A-120K. In particular, in the drawing, the base station 100 and the plurality of user equipments 120A-120K may be connected through single-cell multiple-user multiple-input multiple-output (MU-MIMO) downlink channels. In such a communication environment, the base station 100 may transmit signals using multiple antennas, and the plurality of user equipments 120A-120K may receive signals using multiple antennas. Although only a single cell is illustrated in FIG. 1 for convenience of description, the array antenna of the present disclosure may be applicable to a system including multiple cells also. In addition, although only a single antenna transmitting the signals through the downlink channels is illustrated in FIG. 1, the array antenna according to the present disclosure may be applicable at least some of the plurality of user equipments 120A-120K transmitting signals through a uplink channel.

In the communications system of FIG. 1, it is assumed that the transmitting party (e.g., the base station 100) and the receiving party (e.g., each of the user equipments 120A-120K) have complete knowledge of channel state information. The channel state information may be found through a procedure that the base station 100 transmits a sounding packet or a pilot signal to the user equipments 120A-120K and receives respective channel state information (CSI) from the user equipments 120A-120K. The channel state information (CSI) may be used for setting a precoding matrix and a beam forming for subsequent data transmission. Further, it is assumed that channel characteristics of an uplink channel and a downlink channel are reversible for each of the user equipments 120A-120K, and the uplink channel and the downlink channel have the same characteristics. Hence, the channel state information for the downlink channel may also be used for the uplink channel.

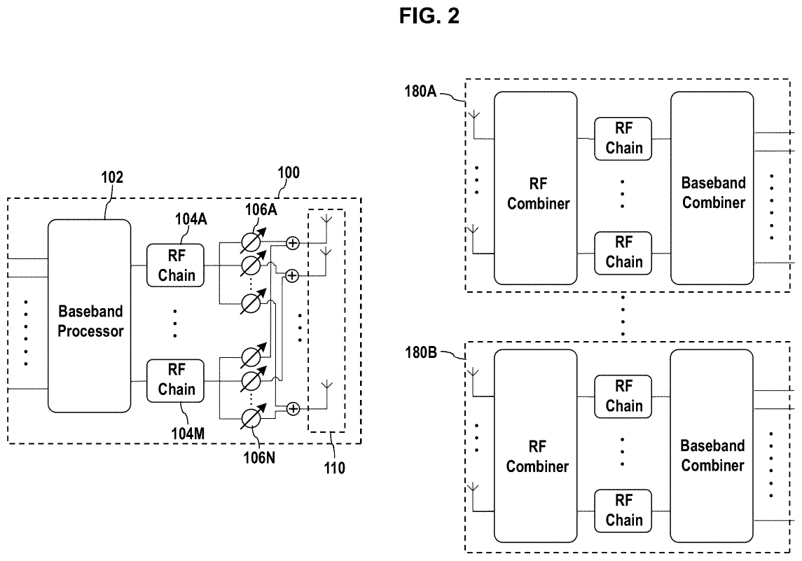

The base station 100 may be equipped with one or more two-dimensional planar array antennas, each of which has a large number of antenna elements integrated to form a two-dimensional plane. The base station 100 has fewer RF chains than a number of antenna elements as shown in FIG. 2 to reduce implementation costs and power consumption and employs a hybrid beamforming architecture which uses both a digital beamforming based on a signal processing in a baseband and an analog phase shifter in a RF domain. The base station 100 may have a fully connected hybrid beamforming structure in which each RF chain are connected to all the antenna elements, or a sub-array based hybrid beamforming structure in which each RF chain is connected to only some of the antenna elements. Here, a group of the antenna elements connected to each RF chain may be referred to as a sub-array antenna. Each user equipment 180A-180K may be equipped with a much smaller number of antennas than the base station 100 and may employ a full-digital beamforming architecture in which the number of the antenna elements are the same as the same number of the RF chains.

FIG. 2 is a schematic block diagram of the base station and the user equipments according to an exemplary embodiment. The base station 100 may include a baseband processor 102, a plurality of RF chains 104A-104M, a plurality of phase shifters 106A-106N, and at least one array antenna 110 including a plurality of antenna elements, and may perform the hybrid beamforming.

The beamforming according to the present disclosure is not limited to the hybrid beamforming but may be the digital beamforming or the analog beamforming. Meanwhile, the base station 100 may further include and a transmission controller (not shown) suitable for controlling the baseband processor 102, the plurality of RF chains 104A-104M, the plurality of phase shifters 106A-106N, and the array antenna 110. The baseband processor 102 determines a message data transmission schedule for each user equipment, encodes a message stream to be transmitted to each user equipment into a data stream, and precodes the data stream with reference to the channel state information for each user equipment to adjust amplitudes and phases of symbols included in the data stream. Each of the RF chains 104A-104M modulates precoded symbols to convert into a RF signal and amplifies the RF signal. Each of the RF chains 104A-104M may include all or some of a low noise amplifier (LNA), a modulator or mixer, a coupler, a frequency multiplier, a phase locked loop (PLL), a voltage controlled oscillator (VCO), and a power amplifier (PA). Each of the phase shifters 106A-106N adjusts a phase of an amplified of the RF signal. The array antenna 110 may output a phase-adjusted RF signal through a MIMO channel.

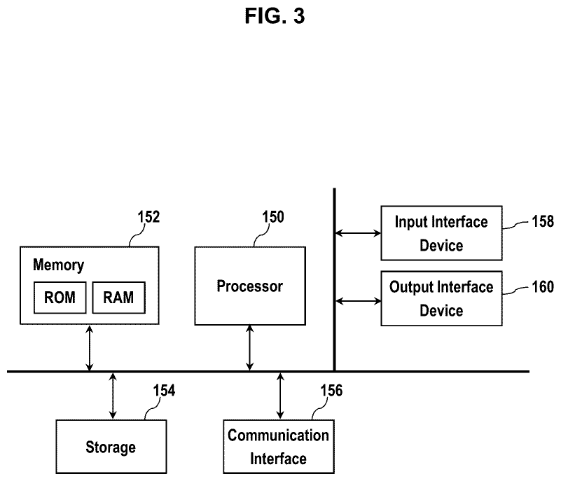

FIG. 3 is a block diagram showing a physical configuration of the transmission controller according to an exemplary embodiment. The transmission controller may include a processor 150, a memory 152, a storage 154, a communication interface 156, an input interface 158, and an output interface 160. At least some of the components of the transmission controller including the processor 150 and the memory 152 may be connected to each other by a bus.

The processor 150 may execute program instructions stored in the memory 152 and/or the storage 154. The processor 150 may include a central processing unit (CPU) or a general processing unit (GPU), or may be implemented by another kind of dedicated processor suitable for performing the method of the present disclosure.

The memory 152 may include, for example, a volatile memory such as a read only memory (ROM) and a nonvolatile memory such as a random access memory (RAM). The memory 152 may load the program instructions stored in the storage 154 to provide to the processor 150 so that the processor 150 may execute the program instructions. In an exemplary embodiment, the program instructions, when executed by the processor 150, may cause the processor 150 to control the beamforming by controlling the baseband processor 102, the plurality of RF chains 104A-104M, the plurality of phase shifters 106A-104M, and the array antenna 110 shown in FIG. 2.

The storage 154 may include an intangible recording medium suitable for storing the program instructions, data files, data structures, and a combination thereof. Examples of the storage medium may include magnetic media such as a hard disk, a floppy disk, and a magnetic tape, optical media such as a compact disk read only memory (CD-ROM) and a digital video disk (DVD), magneto-optical medium such as a floptical disk, and semiconductor memories such as ROM, RAM, a flash memory, and a solid-state drive (SSD).

The communication interface 156 may perform communications with a core network including a switch, and/or one or more repeaters and a nearby base station. The input interface device 158 allows an operator or a user to manipulate or input commands for the transmission controller, and the output interface device 160 may display an operating status and an operating result of the transmission controller.

FIG. 4 is a front view of the array antenna 110 according to an exemplary embodiment. The array antenna 110 may include a metallic base plate 112 and a plurality of antenna elements 200 arranged periodically in or on the base plate 112 to form a two-dimensional plane. Each antenna element 200 may have a shape with an approximately hexagonal cross section. In an exemplary embodiment, each antenna element 200 may be implemented based on a resonant cavity as described below, may be fed through respective waveguide, and may operate independently from the other antenna elements. Accordingly, the array antenna 110 may form as many beams as the number of the antenna elements 200, that is, multiple resonance hole antennas according to the present disclosure. Here, a desired beam may be formed and steered to a desired direction by grouping the antenna elements and applying a common signal to a group of the antenna elements or varying the phase only or both the phase and the amplitude of the RF signal fed to each antenna element 200. That is, the array antenna 110 is a beam reconfigurable array antenna which may reconfigure the beam radiated by the array antenna 110 by changing the phase only or both the phase and the amplitude of the signal fed to each antenna element 200.

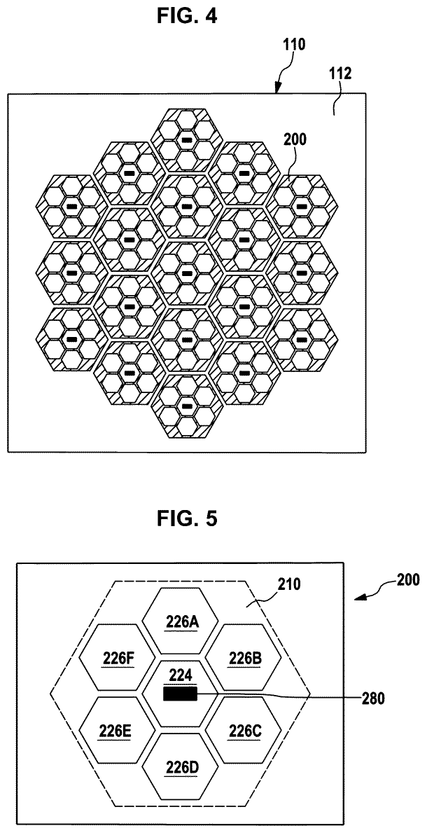

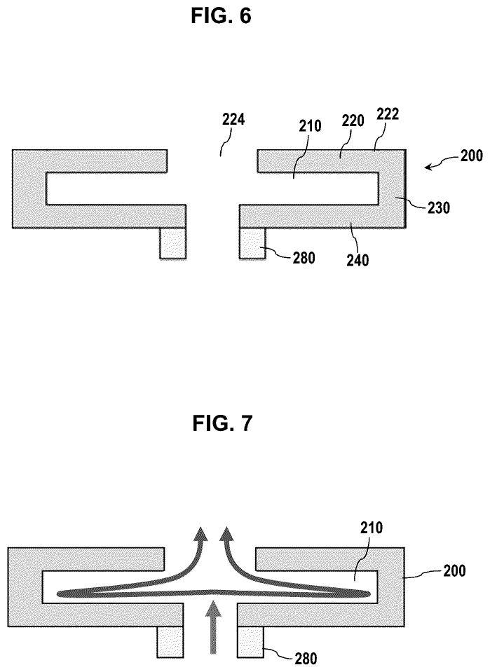

FIG. 5 is a front view of the antenna element 200 according to an exemplary embodiment, and FIG. 6 is a cross-sectional view of the antenna element 200 according to an exemplary embodiment.

The antenna element 200 may be implemented based on a resonant cavity 210 installed in the base plate 112. In this disclosure, the resonance cavity 210 may refer to a structure including a front plate 220, a lateral plate 230, and a rear plate 240, or a space surrounded by the plates 220, 230, and 240. According to an exemplary embodiment, the resonance cavity 210 may be buried behind the base plate 112 such that a front surface 222 of the front plate 220 has the same height as a front surface of the base plate 112. Alternatively, the antenna elements 200 may share the base plate 112. That is, a plurality of resonance cavities 210 may be formed on a rear wall of the base plate 112 such that front portions of the resonance cavities 210 are limited by the base plate 112 rather than the front plate 220. The front plate 220, the lateral plate 230, and the rear plate 240 limiting the resonance cavity 210 may be made of ceramic or metallic material. According to an exemplary embodiment, the resonant cavity 210 may have a hexagonal cross section. However, the present disclosure is not limited thereto, and the resonant cavity 210 may have a cross section of another kind of polygon such as a rectangle and a square or may have a circular cross section.

A feeding waveguide 280 for feeding a transmit signal to the resonant cavity 210 may be coupled to the rear wall of the resonant cavity 210. In an exemplary embodiment, the feeding waveguide 280 may be installed to extend backwards from a center of the rear plate 240. The feeding waveguide 280 may supply the transmit signal to the resonant cavity 210. The feeding waveguide 280 may have a shape of a hollow tube or a pipe and may be made of a conductor such as copper. The feeding waveguide 280 may have a rectangular, square, or circular cross section. One side of the feeding waveguide 280 having the rectangular or square cross section or the inner diameter of the feeding waveguide 280 having the circular cross section may have a size close to a wavelength of the transmit signal.

A radiation hole 224, which is an opening penetrating the front plate 220 to open the resonance cavity 210 toward the front, is formed at a position on the front plate 220 opposite to a position where the feeding waveguide 280 is coupled to the rear plate 240. In case that the feeding waveguide 280 is coupled to the resonant cavity 210 at the center of the rear plate 240, the radiation hole 224 may be formed at the center of the front plate 220. In addition, a plurality of auxiliary radiation holes 226A-226F are formed around the radiation hole 224. Similarly to the radiation hole 224, the plurality of auxiliary radiation holes 226A-226F are formed to penetrate the front plate 220 of the resonance cavity 210 to open the resonance cavity 210 toward the front of the antenna element 200. According to an exemplary embodiment, six auxiliary radiation holes 226A-226F may be arranged to surround the radiation hole 224 and to be symmetrical about the radiation hole 224. Each of the radiation hole 224 and the auxiliary radiation holes 226A-226F may have a hexagonal cross section. The radiation hole 224 and the auxiliary radiation holes 226A-226F may have a size close to the wavelength of the transmit signal. However, the present disclosure is not limited thereto, and the inner diameters of the radiation hole 224 and the auxiliary radiation holes 226A-226F may have a size different from the wavelength of the transmit signal. Meanwhile, the size and shape of the radiation hole 224 may be different from those of the auxiliary radiation holes 226A-226F.

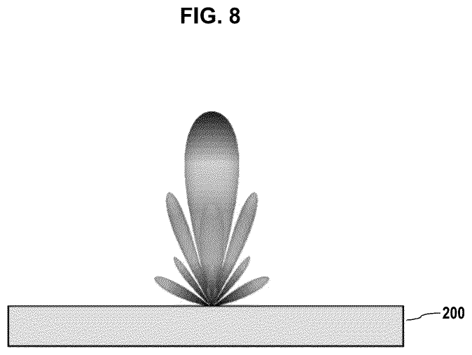

FIG. 7 shows a propagation path of a radiation signal in the antenna element 200, and FIG. 8 shows a signal radiation pattern of the antenna element 200. The transmit signal fed through the feeding waveguide 280 may be converted into an RF transmit signal at an end of the feeding waveguide 280 at a side of the resonance cavity 210, and the RF transmit signal is amplified by a resonance phenomenon inside the resonant cavity 210. An amplified RF transmit signal is emitted to the front of the antenna element 200 through the radiation hole 224 and the auxiliary radiation holes 226A-226F. The radiation signal emitted to the front of the antenna element 200 may have a radiation pattern in which a main lobe is formed in a direction perpendicular to the front surface 122 of the antenna element 200.

As mentioned above, according to an exemplary embodiment, the radiation hole 224 and the auxiliary radiation holes 226A-226F may have the hexagonal cross section. In an exemplary embodiment, the inner diameters of the radiation hole 224 and the auxiliary radiation holes 226A-226F may have a size close to the wavelength of the transmit signal. However, the present disclosure is not limited thereto, and the inner diameter of the radiation hole 224 and the auxiliary radiation holes 226A-226F may have a size different from the wavelength of the transmit signal.

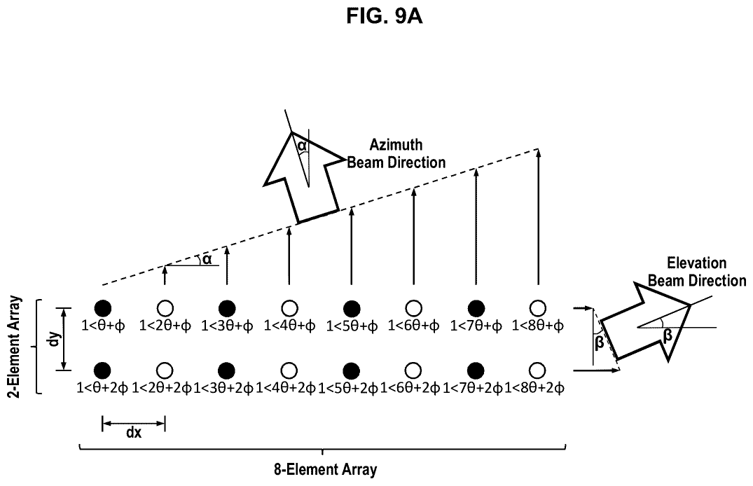

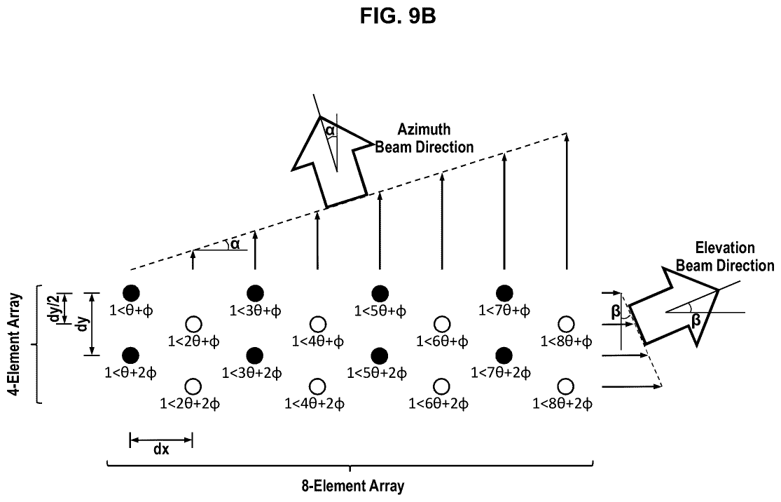

FIG. 9A illustrates a general arrangement of radiators and a beam steering control under the general arrangement, and FIG. 9B illustrates an arrangement of the radiation holes and a beam steering control under the arrangement according to an exemplary embodiment of the present disclosure. In general, in an array antenna in which radiators are regularly arranged, it is necessary to design a structure of the array antenna such that a spacing of between adjacent radiators is less than one wavelength in order to combine radiated signals while suppressing grating lobes. However, in the array antenna operating at a high frequency in the terahertz frequency band, it is difficult to design the spacing of between adjacent radiators to be less than one wavelength because the wavelength is very short. If the spacing of between adjacent radiators is larger than one wavelength, the radiated signals may not be combined effectively, which may lower antenna gain and cause to generate the grating lobes. According to an exemplary embodiment, the cross sections of the radiators, i.e., the radiation holes 224 and the auxiliary ration holes 226A-226F, are formed to be hexagonal, and the radiation holes 224 and 226A-226F are arranged to stagger each other as shown in FIG. 9B instead of arranging the radiation holes regularly in the horizontal and vertical directions as shown in FIG. 9A. Accordingly, the spacing between the radiation holes 224 and 226A-226F in the horizontal and vertical directions is dx/2 and dy/2, respectively, which may be reduced to half compared with the structure shown in FIG. 9A. As a result, the radiated signals may be combined effectively, which enables to suppress the grating lobes and minimize a steering error during a beam steering control. In FIG. 9B, the radiation holes 224 and 226A-226F would be arranged in a shape of a honeycomb.

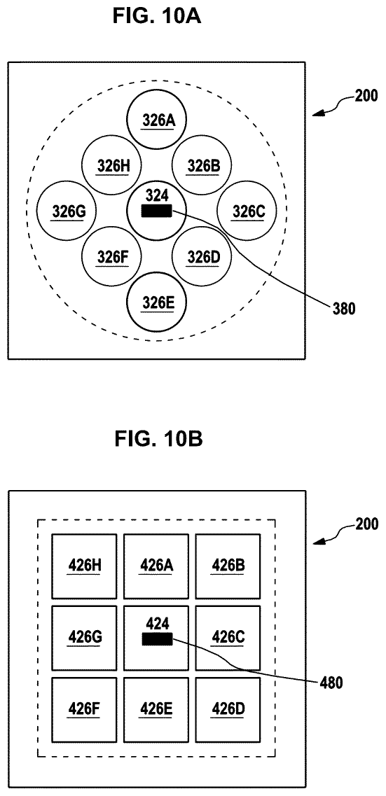

However, the present disclosure does not completely exclude the arrangement pattern of the radiation holes 224 and 226A-226F shown in FIG. 9A. FIGS. 10A and 10B show alternative arrangement patterns of the radiation holes 224 and 226A-226F, which are similar to the pattern shown in FIG. 9A. In the antenna element 200 according to the embodiment shown in FIG. 10A, a radiation hole 324 disposed at a position opposite to the waveguide 380 and auxiliary radiation holes 326A-326H disposed around the radiation hole 324 may have circular cross sections. As can be seen in the drawing, eight auxiliary radiation holes 326A-326H may be arranged around the radiation hole 324. In the antenna element 300 according to the embodiment shown in FIG. 10B, the radiation hole 424 disposed at a position opposite the waveguide 480 and the auxiliary radiation holes 426A-426H disposed around the radiation hole 424 may have square cross sections. Eight auxiliary radiation holes 426A-426H may be arranged around the radiation hole 424. A shape and size of each of the auxiliary radiation holes 426A-426H may be the same as that of the radiation hole 424. Alternatively, however, the shape or size of each of the auxiliary radiation holes 426A-426H may be different from that of the radiation hole 424.

Referring back to FIG. 4, the array antenna 110 according to an exemplary embodiment has a plurality of antenna elements 200 arranged periodically in or on the metallic base plate 112 to form a two-dimensional plane as mentioned above. Each antenna element 200 is implemented based on a resonant cavity 210 formed on, in or behind the base plate 202, and the radiation hole 224 is formed through a front wall of the resonant cavity 210 and a plurality of the auxiliary radiation holes 226A-226F are formed around the radiation hole 224. Accordingly, each antenna element 200 may be operable independently from the other antenna elements by being fed signal through the waveguide 280, and/or the array antenna 110 may form as many beams as the number of multiple resonant hole antennas, i.e., the antenna elements 200. Here, it is possible to reconfigure the beam radiated by the array antenna 110 by grouping the antenna elements and applying a signal to a group of the antenna elements or varying the phase or both the phase and the amplitude of the RF signal fed to each antenna element 200 to form a desired beam and steer the beam to a desired direction.

The operation of the array antenna 110 shown in FIG. 4 will now be described in more detail.

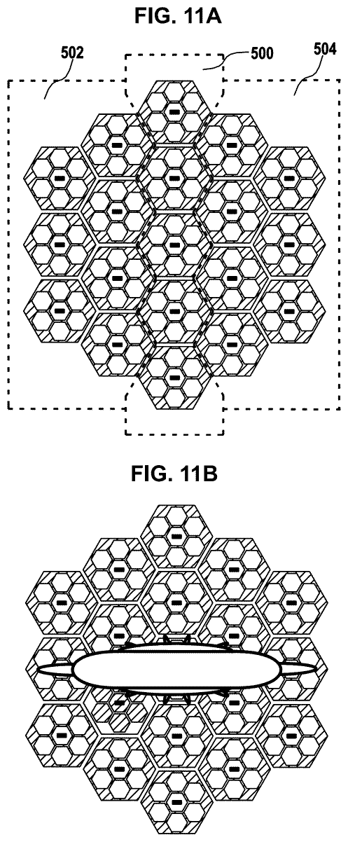

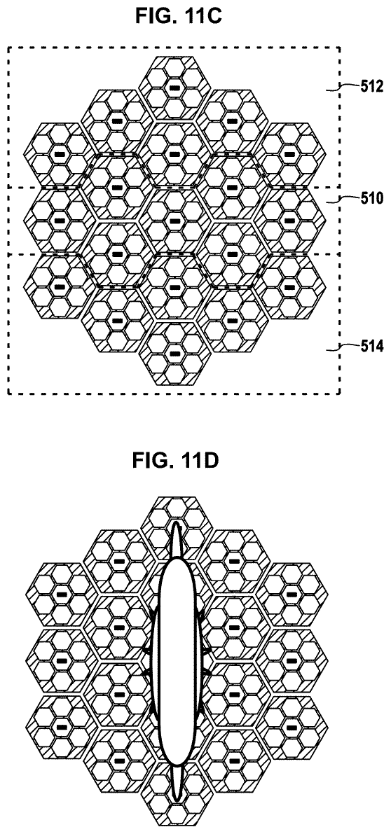

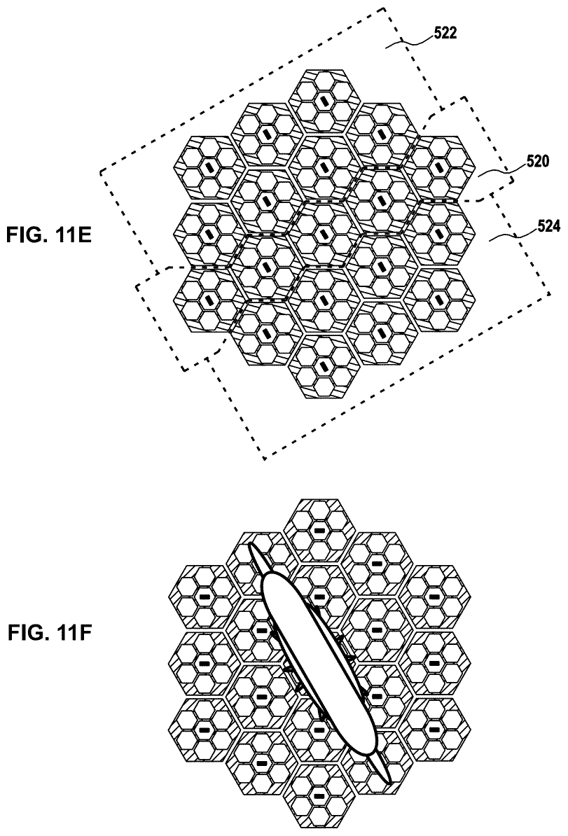

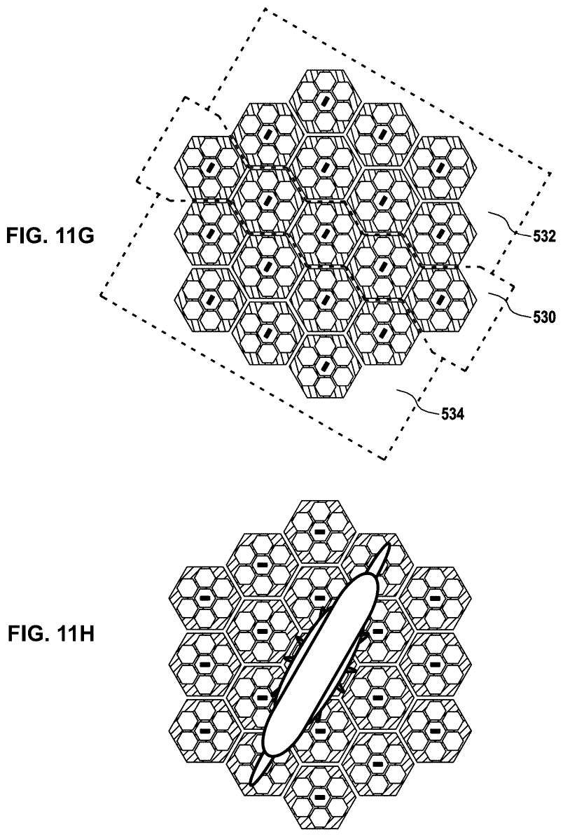

FIGS. 11A-11H show on/off patterns of the antenna elements and resulting radio wave radiation patterns when the array antenna 110 operates as a multiple resonance hole array antenna for passive beamforming. A term “passive beamforming” used herein refers to a beamforming performed by controlling on/off states of the antenna elements, that is, by changing a signal application state to each antenna element. In case that an antenna element group 500 disposed in a vertical direction along a virtual vertical center line of the array antenna is turned on, that is, an in-phase signal is supplied to all the antenna elements belonging to the antenna element group 500, while remaining antenna element groups 502 and 504 are turned off, that is, the signal is not supplied to the antenna elements in the antenna element groups 502 and 504, as shown in FIG. 11A, a main lobe indicating a strong intensity of a combined beam may be formed to extend in a direction perpendicular to a face of the array antenna 110 and in a vertical direction perpendicular to a direction in which the turned-on antenna elements are disposed as shown in FIG. 11B. In case that an antenna element group 510 disposed in a horizontal direction along a virtual horizontal center line of the array antenna is turned on and the in-phase signal is supplied to the antenna elements in the antenna element group 510 while remaining antenna element groups 512 and 514 are turned off as shown in FIG. 11C, the main lobe may be formed to extend in a direction perpendicular to the face of the array antenna 110 and in a vertical direction perpendicular to a direction in which the turned-on antenna elements are disposed as shown in FIG. 11D.

In case that an antenna element group 520 of the turned-on array antennas is disposed to extend from a upper right side to a lower left side of the array antenna 110 and remaining antenna element groups 522 and 524 are turned off as shown in FIG. 11E, the main lobe may be formed to extend in a direction perpendicular to the face of the array antenna 110 and in a direction perpendicular to a direction in which the turned-on antenna elements are disposed as shown in FIG. 11F. Only back lobes or side lobes which are weaker than the main lobe may be formed in the other directions. In case that an antenna element group 530 of the turned-on array antennas is disposed to extend from a upper left side to a lower right side of the array antenna 110 and remaining antenna element groups 532 and 534 are turned off as shown in FIG. 11G, the main lobe may be formed to extend in a direction perpendicular to the face of the array antenna 110 and in a direction perpendicular to a direction in which the turned-on antenna elements are disposed as shown in FIG. 11H. Only back lobes or side lobes which are weaker than the main lobe may be formed in the other directions.

Therefore, it is possible to radiate the radio wave with a maximum gain in a desired direction while minimizing a radiation of the radio wave in undesired directions. Although the above description is focused on a case of transmitting the signal, the array antenna 110 according to an exemplary embodiment may operate similarly in the case of receiving the signal.

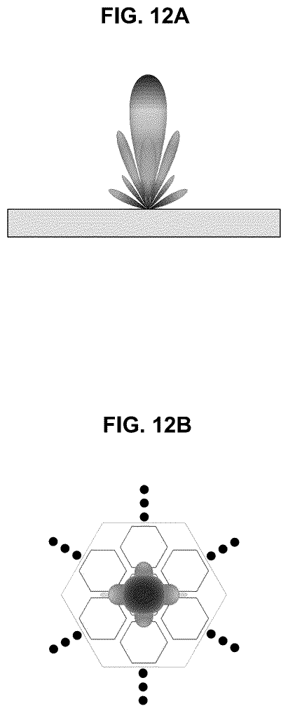

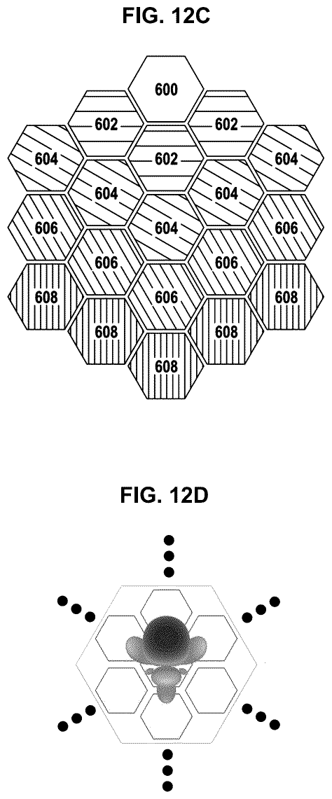

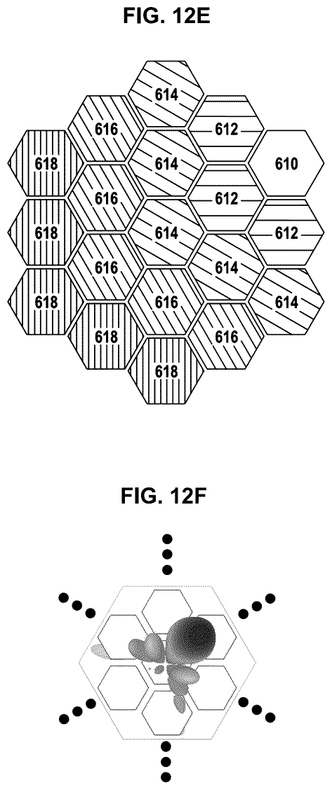

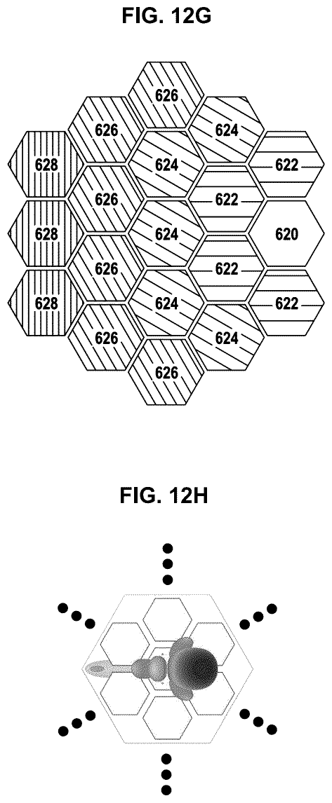

FIGS. 12A-12H show signal phase arrangement patterns of the antenna elements and resulting radio wave radiation patterns when the array antenna 110 operates as a multiple resonance hole array antenna for active beamforming.

When signals of the same phase are supplied to all the antenna elements, a combined antenna beam is radiated from a front center of the array antenna in a direction perpendicular to the front face of the array antenna as shown in FIGS. 12A and 12B. In order to obtain the beamforming of the array antenna in a desired form, the beam pattern may be steered by adjusting the phase or both the amplitude and the phase of the signal supplied to each antenna element. In particular, a signal of each phase may be commonly supplied to a plurality of antenna elements to improve the antenna gain while forming the combined antenna beam in a desired direction.

In FIG. 12C, when the antenna beam is to be steered to the direction of an antenna element 600, a signal of a first phase may be supplied to the antenna element 600, and a signal of a second phase may be supplied to a group of a plurality of antenna elements 602 adjacent to the antenna element 600 and arranged to be approximately perpendicular to or symmetrical with respect to a virtual straight line connecting the antenna element 600 and a center of the array antenna. A signal of a third phase may be supplied to a group of a plurality of antenna elements 604 adjacent to the antenna elements 602 and arranged to be approximately perpendicular to or symmetrical with respect to the virtual straight line. A signal of a fourth phase may be supplied to a group of a plurality of antenna elements 606 adjacent to the antenna elements 604 and arranged to be approximately perpendicular to or symmetrical with respect to the virtual straight line. A signal of a fifth phase may be supplied to a group of a plurality of antenna elements 608 adjacent to the antenna elements 606 and arranged to be approximately perpendicular to or symmetrical with respect to the virtual straight line. In this case, an antenna beam deflected in a direction perpendicular to the arrangement of each antenna element group 602, 604, 606, and 608, that is, in the direction of the antenna element 600, may be formed as shown in FIG. 12D.

In FIG. 12E also, a signal of the same phase may be supplied to the antenna elements assigned the same reference numerals. That is, a signal of a first phase may be supplied to an antenna element 610, a signal of a second phase may be supplied to an antenna element group 612, a signal of a third phase may be supplied to an antenna element group 614, a signal of a fourth phase signal may be supplied to an antenna element group 616, and a signal of a fifth phase may be supplied to an antenna element group 618. In this case, an antenna beam deflected in a direction perpendicular to the arrangement of each antenna element group 612, 614, 616, and 618, that is, in the direction of the antenna element 610, may be formed as shown in FIG. 12F.

In FIG. 12G also, a signal of the same phase may be supplied to the antenna elements assigned the same reference numerals. That is, a signal of a first phase may be supplied to an antenna element 620, a signal of a second phase may be supplied to an antenna element group 622, a signal of a third phase may be supplied to an antenna element group 624, a signal of a fourth phase signal may be supplied to an antenna element group 626, and a signal of a fifth phase may be supplied to an antenna element group 628. In this case, an antenna beam deflected in a direction perpendicular to the arrangement of each antenna element group 622, 624, 626, and 628, that is, in the direction of the antenna element 620, may be formed as shown in FIG. 12H.

Although the steering of the antenna beam has been described only for some exemplary directions, the antenna beam may be steered for all the other directions in the same manner.

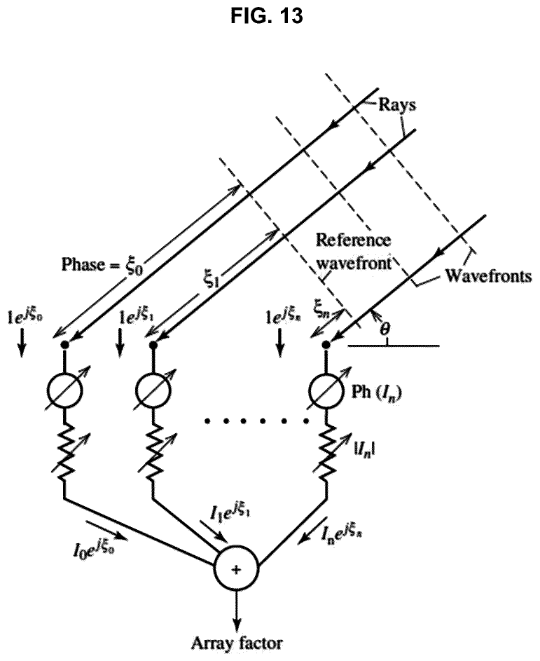

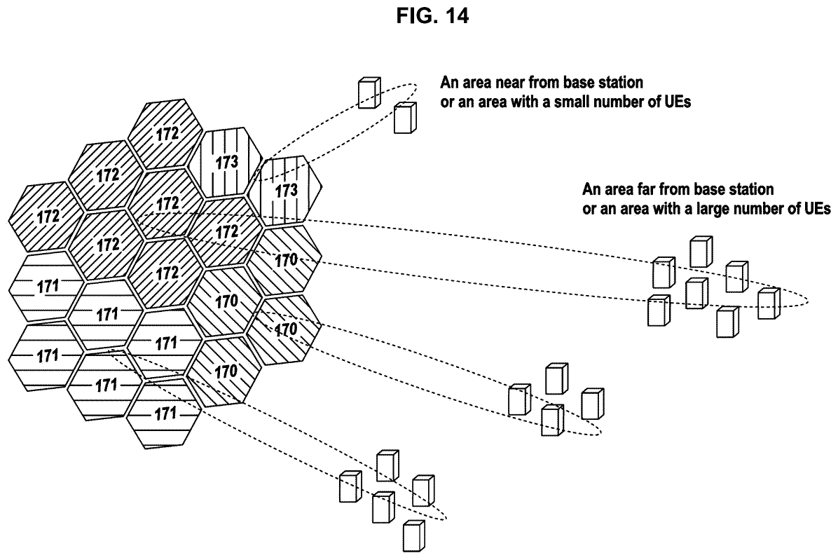

A specific value of the signal phase for each antenna element group may be calculated using a general formula for an array factor (AF), which will now be described. An array antenna improves a directivity in a desired direction by an arrangement of the antenna elements and an application of weights to each antenna element, and the array factor is a function enabling to calculate an overall antenna directivity of the array antenna comprised of two or more isotropic antenna elements from the directivity of any one antenna element. FIG. 13 is an equivalent circuit diagram of a signal receiving stage including an array antenna. The array factor of an array antenna may be expressed as a linear combination of spatial phase delays of the antenna elements {e^{jξ}^{₀}, e^{jξ}^{₁}, . . . } and amplitudes of excitation signals {I₀, I₁, . . . } as shown in Equation 1. If it is assumed that there is no coupling between the antenna elements, the radiation pattern of the array antenna may be expressed by a product of the radiation pattern of an individual antenna element and the array factor of the array antenna. Accordingly, the signal phase of each antenna element can be derived by distributing the phase delays of the antenna elements such that the array factor representing the desired steering of the antenna beam may be obtained. Although FIG. 13 depicts the signal receiving stage, a signal transmitting stage may also be depicted similarly.

$$AF = {I}_{0} {e}^{j {ξ}_{0}} + {I}_{1} {e}^{j {ξ}_{1}} + {I}_{2} {e}^{j {ξ}_{2}} + ⋯ \qquad [ Equation 1 ]$$

For example, the beam is to be steered upward as shown in FIG. 12D, e.g., about 20 degrees to the +y direction, the phase of the signal supplied to the antenna element 600 in FIG. 12C 602 may be adjusted to 300 degrees, the phase of the signal supplied to the antenna element group 602 may be adjusted to 300 degrees, the phase of the signal supplied to the antenna element group 602 may be adjusted to 225 degrees, the phase of the signal supplied to the antenna element group 604 may be adjusted to 150 degrees, the phase of the signal supplied to the antenna element group 606 may be adjusted to 75 degrees, and the phase of the signal supplied to the antenna element group 608 may be adjusted to 0 degree. The antenna beam may be steered to any desired direction in such a manner.

FIG. 14 illustrates an example of the beam steering accomplished by a separation or combining of the array antennas in a massive multiple input-multiple output (massive MIMO) system. Each section labeled in FIG. 14 may correspond to one antenna element. Alternatively, however, each section may correspond to one array antenna shown in FIG. 4, 11A, 11C, 11E, 11G, 12C, 12E, or 12G, for example. The beam may be steered by combining only a small number of the array antennas (for example, the array antennas labeled 173) for an area close to the base station or an area with a small number of user equipments. Contrarily, the beam may be steered by combining multiple number of the array antennas (for example, the array antennas labeled 172) for an area relatively far from base station and/or an area with a large number of user equipments. As a result, a beam coverage may be expanded and the frequency may be used efficiently.

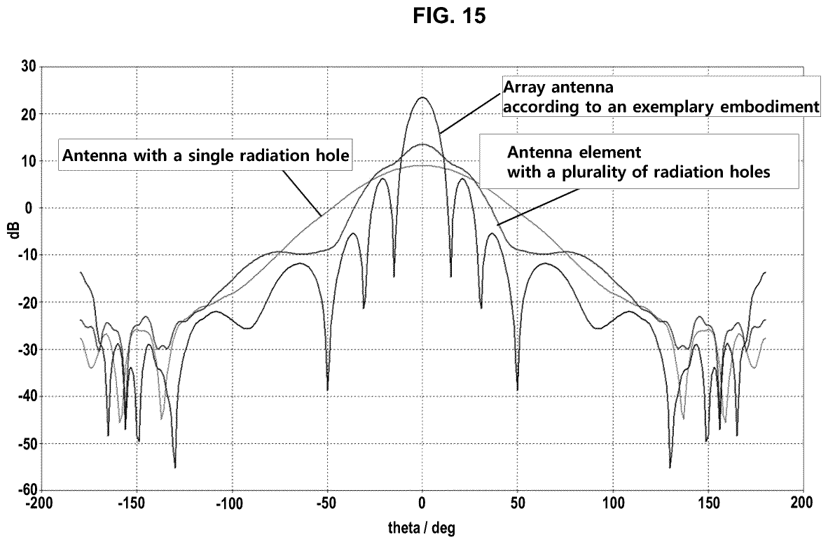

FIG. 15 is a graph showing simulation results for antenna gains. The drawing shows gains of three types of antennas: (1) a single antenna element with a single radiation hole formed in the resonant cavity, (2) a single antenna element with a plurality of radiation holes formed in the resonant cavity, and (3) an array antenna with a plurality of antenna elements. It can be seen in the drawing that the gain of the single antenna element according to the exemplary embodiment is higher than the gain of the single antenna element in which just a single radiation hole is formed, and that the array antenna including a plurality of antenna elements according to the present disclosure reveals a highest gain.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An antenna device, comprising:
a resonance cavity; and
a feeding waveguide coupled to a rear wall of the resonance cavity,
wherein a plurality of radio wave radiation holes are formed on a face of the resonance cavity opposite to a position where the feeding waveguide is coupled to the resonance cavity.

2. The antenna device as claimed in claim 1, wherein the plurality of radio wave radiation holes comprises:
a main radiation hole formed through a front face of the resonance cavity at a position opposite to the position at the rear wall where the feeding waveguide is coupled to the resonance cavity; and
a plurality of auxiliary radiation holes formed through the front face of the resonance cavity to surround the main radiation hole.

3. The antenna device as claimed in claim 2, wherein the resonant cavity has a polygonal cross section.

4. The antenna device as claimed in claim 3, wherein the resonant cavity has a square cross section.

5. The antenna device as claimed in claim 2, wherein each of the plurality of radio wave radiation holes has a hexagonal cross section, and the plurality of radio wave radiation holes are arranged in a shape of a honeycomb.

6. The antenna device as claimed in claim 2, wherein the main radiation hole is different from the plurality of auxiliary radiation holes in at least one of a shape and a size.

7. An array antenna device, comprising:
a plurality of antenna elements periodically arranged to form a two-dimensional planar array; and
a plurality of feeding waveguides each provided to supply a transmit signal to a corresponding one of the plurality of antenna elements,
wherein each of the plurality of antenna elements comprises a resonance cavity and is coupled to one of the plurality of feeding waveguides at a rear wall,
wherein, in each of plurality of antenna elements, a plurality of radio wave radiation holes are formed on a face of the resonance cavity opposite to a position where the feeding waveguide is coupled to the resonance cavity.

8. The array antenna device as claimed in claim 7, wherein the plurality of radio wave radiation holes comprises:
a main radiation hole formed through a front face of the resonance cavity at a position opposite to the position at the rear wall where the feeding waveguide is coupled to the resonance cavity; and
a plurality of auxiliary radiation holes formed through the front face of the resonance cavity to surround the main radiation hole.

9. The array antenna device as claimed in claim 8, wherein the resonant cavity has a polygonal cross section.

10. The array antenna device as claimed in claim 9, wherein the resonant cavity has a square cross section.

11. The array antenna device as claimed in claim 8, wherein each of the plurality of radio wave radiation holes has a hexagonal cross section, and the plurality of radio wave radiation holes are arranged in a shape of a honeycomb.

12. The array antenna device as claimed in claim 8, wherein the main radiation hole is different from the plurality of auxiliary radiation holes in at least one of a shape and a size.

13. A signal transmitter apparatus, comprising:
a signal generator configured to generate a transmit signal;
a phase shifter configured to receive the transmit signal from the signal generator and adjust the a phase of the transmit signal; and
at least one array antenna configured to radiate a phase-adjusted transmit signal from the phase shifter as a wireless signal,
wherein the at least one array antenna comprises:
a plurality of antenna elements periodically arranged to form a two-dimensional planar array; and
a plurality of feeding waveguides each provided to supply the phase-adjusted transmit signal to a corresponding one of the plurality of antenna elements,
wherein each of the plurality of antenna elements comprises a resonance cavity and is coupled to one of the plurality of feeding waveguides at a rear wall,
wherein, in each of plurality of antenna elements, a plurality of radio wave radiation holes are formed on a face of the resonance cavity opposite to a position where the feeding waveguide is coupled to the resonance cavity.

14. The signal transmitter apparatus as claimed in claim 13, wherein the plurality of radio wave radiation holes comprises:
a main radiation hole formed through a front face of the resonance cavity at a position opposite to the position at the rear wall where the feeding waveguide is coupled to the resonance cavity; and
a plurality of auxiliary radiation holes formed through the front face of the resonance cavity to surround the main radiation hole.

15. The signal transmitter apparatus as claimed in claim 14, wherein the resonant cavity has a polygonal cross section.

16. The signal transmitter apparatus as claimed in claim 15, wherein the resonant cavity has a square cross section.

17. The signal transmitter apparatus as claimed in claim 14, wherein each of the plurality of radio wave radiation holes has a hexagonal cross section, and the plurality of radio wave radiation holes are arranged in a shape of a honeycomb.

18. The signal transmitter apparatus as claimed in claim 14, wherein the main radiation hole is different from the plurality of auxiliary radiation holes in at least one of a shape and a size.

19. The signal transmitter apparatus as claimed in claim 13, wherein the plurality of antenna elements are divided into two or more antenna element groups, and a supply of the phase-adjusted transmit signal is controlled to turn on and off equally for all antenna elements of each antenna element group.

20. The signal transmitter apparatus as claimed in claim 13, wherein the plurality of antenna elements are divided into two or more antenna element groups, and the phase-adjusted transmit signal of which phase is adjusted by a same amount is supplied for all antenna elements of each antenna element group.
